(19) United States
(12) Patent Application Publication
(10) Pub. No.: US 2002/0090919 A1
(43) Pub. Date: Jul. 11, 2002

(54) Adapter to convert cell phone to desktop telephone

(76) Inventor: Ofer Hofman, Timrat (IL)

Correspondence Address: BROWDY AND NEIMARK, P.L.L.C., 624 Ninth Street, N.W., Washington, DC, 20001, US

(21) Appl. No.: 09/766,668

(22) Filed: Jan. 23, 2001

(30) Foreign Application Priority Data
Jan. 9, 2001 (IL) 140817

(51) Int. Cl. H04B 1/38

(52) U.S. Cl. 455/90; 455/569; 455/74.1

(57) ABSTRACT

An adapter to convert a mobile cell phone having a battery-powered transceiver and a key pad into a desktop telephone, the adapter including a console that rests on a desk top and is provided with a cradle to nest the cell phone. Next to the cradle is a socket to accommodate a hand set whose microphone and speaker are connected by a cord extending from the hand set to a plug inserted into a console jack. The console jack is connected by an interface network to a plug mounted on the cradle. The cell phone is provided with a jack having contacts which are connectable to an external microphone and speaker to supplant those in the cell phone connected to thc transceiver. Insertion of the cell phone in the cradle causes the cradle plug to engage the cell phone jack, thereby connecting the microphone and speaker of the hand set via the interface network to the transceiver of the cell phone whose key pad now functions as the dialing pad of the desktop telephone.

### FIELD OF THE INVENTION

This invention relates generally to portable, battery-powered radio-telephones, and in particular to an adapter for converting a mobile cell phone into a desktop telephone having a, hand set.

### BACKGROUND OF THE INVENTION

A cellular or cell phone is a portable radio telephone that is self sufficient, the phone being powered by a rechargeable battery. Contained in the case of a cell phone is a transceiver connected to an internal microphone and speaker. On the face of the case is a dialing key pad and all LCD display screen.

At the lower end of a conventional cell phone is a jack having contacts which when engaged by a plug inserted in the jack, then connect the cell phone to a battery charger or to an external microphone and speaker which supplant those in the cell phone.

Cell phone systems employ equipment operating in an assigned band of the microwave range A user of a cell phone can move from cell to cell in an urban environment, the system keeping track of these movements, whether or not the user is initiating or receiving a radio-telephone interconnect call.

A major advantage of a cell phone is its mobility, for it may be carried on the person of its user, making it possible to operate the phone in both indoor and outdoor environments as well as on moving vehicles. There are however certain drawbacks to tire use of a cell phone, one being that it is difficult to operate when the ambient noise level is high. These noises are picked up by the cell phone transceiver and mask the user's voice. Extraneous noises beard by the user of the cell phone, interfere with the vocal sounds coming from the cell phone speaker.

Another drawback of growing international concern is that because a cell phone, when in use, is placed against the head of its user, microwave radiation from the cell phone which includes a microwave transmitter, penetrates the user's head and may have damaging effects on his brain.

The adverse effects of microwave radiation are similar to those experienced with X-ray radiation in that they are cumulative in nature. While a brief exposure to microwave radiation may not be harmful, when a cell phone user in the course of a single day makes and receives many calls as is often the case, then the cumulative effects of exposure to microwave energy may be substantial.

In order to reduce the exposure of a user's brain to microwave radiation emanating from a cell phone, there is disclosed in the 1997 German patent DE 296 12622 a cell phone connected by a cable to a head set having a microphone and a speaker, the cell phone being supported on the waist of the user.

Because the waist-mounted cell phone is now well spaced from the user's brain, its exposure to microwave radiation is reduced, but only with respect to radiation from the antenna of tire cell phone. However the cord of the head set which runs from the head of the user to the cell phone acts as an auxiliary antenna which radiates microwave energy in the vicinity of the brain. Again, it must be borne in mind that the effects of such radiation are cumulative, and while radiation from the auxiliary antenna may be weak, its cumulative effects over a prolonged period may be strong.

A conventional desktop telephone is a wired stationary instrument, for it is tethered by a cable to a telephone line outlet which connects it to a telephone network, the line also supplying dc power to the telephone set. The console of a desktop telephone rests on a desk or tabletop and is provided with a dialing keypad next to which is a socket to accommodate a hand set housing a microphone and a speaker. The hand set is connected by a cord extending from a console jack.

In a conventional desktop telephone in which the hand set is received in a socket on the console, the socket has mounted therein a depressible control switch When a user lif s the hand set in order to make a call, the resultant switching action. is such as to produce a dialing tone permitting the user to dial the number of tie party he wishes to call. When the user returns the hand set to its socket, the resultant switching action is such as to inactivate the phone so that it is only responsive to a ring signal indicative of an incoming call. Then when the user lifts the hand set away from its socket to receive the incoming call, the resultant switching action activates the telephone and connects the head set to the telephone line.

A wired desktop telephone presents no problem in regard to microwave radiation. A major advantage of this telephone, whether installed in a house, an office or in any other facility, lies in its convenience and comfort. A user of a desktop telephone is usually comfortably seated next to the desk on which the telephone is placed and is therefore able while on the phone to take notes on a desk pad or to consult papers placed on tie desktop. Also the user, instead of bolding the hand set ill one hand while on the phone, can wedge the phone between his shoulder and head, and then have both hands free as he converses with the caller.

A drawback of a wired conventional desktop telephone is that its hand set is tied to it by a cord and therefore cannot be used away from the desk. To overcome this drawback, it is known to provide a cordless hand set which incorporates a microwave transceiver communicating with a base unit connected by the cable to a telephone-line wall outlet. One such arrangement is disclosed in the U.S. patent to Heistab et al. U.S. Pat. No. 6,073,031. Since a cordless hand set in, some instances includes a microwave transmitter that is held against the head, it presents the same radiation problem as a conventional cell phone.

Inasmuch as an adapter in accordance with the invention which serves to convert a cell phone into a desktop telephone having a hand set whose microphone and speaker then supplant those in the cell phone, of prior art interest is the U.S. Pat. No. 5,588,041 to Meyers Jr. et al.

The Meyers et al. patent discloses a cell phone useable in a vehicle, the cell phone being associated with a hand set whose cord plugs into the jack of tie cell phone, whereby the microphone and speaker of the hand set then supplant those in the cell phone. The hand set is suspended from. a hang-up cup. This combination of a hand set and cell phone does not create a desktop telephone in which switching actions are effected when the hand set is lifted from a socket on a desk console, and when the bead set is placed back in its socket.

A desktop telephone in accordance with the invention includes a cradle to nest a cell phone. Hence, of prior art interest in this regard in the 1998 British Patent CGB 232 0990. The British patent discloses a cell phone received in a cradle attached to the trouser waist of the user. A headset is suspended from the cradle, the head set which includes a microphone and an earphone being connected by an extendable cable to the cell phone in the cradle. This arrangement cannot function as a desktop telephone.

### SUMMARY OF TUE INVENTION

In view of the foregoing, the main object of this invention is to provide an adapter for converting a cell phone into a desktop telephone.

More particularly, an object of this invention is to provide an adapter of the above type having a console on which. is mounted a cradle which receives a cell phone and connects it to a hand set accommodated in a socket adjacent the cradle, thereby integrating the cell phone with the desktop telephone.

Also an object of the invention is to provide an adapter for a video cell phone having a video camera and a video screen to convert this phone into a video desktop telephone.

Among the significant advantages of a desktop telephone in accordance with the invention are the following:

A. The telephone, though. capable of carrying out all of the actions of a conventional desktop telephone, is wireless and therefore requires no connection to a telephone line outlet or to a power line outlet.

B. The telephone behaves like an ordinary desktop telephone, for when its hand set is lifted away from its socket the resultant switching action activates the telephone, and when the hand set is returned to its socket, the resultant switching action renders the telephone inactive in readiness to receive an incoming call.

C. The telephone, tough mainly intended to be placed on a desktop, can be placed at whatever site in a residence in an office or elsewhere suits the convenience of its user.

D. The telephone combines the advantages of a conventional cell phone with those of a standard desktop telephone without their drawbacks. The cell phone converted by the adapter into a desktop telephone can readily be attached to and detached therefrom. Thus when the user leaves his home, he can take along his cell phone, and when he returns, he can then put it back into the adapter. Hence the user need not go to the expense of having both a cell phone and a desktop phone, nor will he be required to pay different companies for the calls he makes.

F. Despite the fact that a desktop telephone in accordance with the invention includes a microwave transmitter, when its hand set is held next to the user's head, no microwave energy radiates from the hand set or from its cord. Consequently, the wireless telephone is safe to use.

F. All of the features incorporated in a standard cell phone in which data is displayed on an LCD or other screen such as call monitoring aid call waiting are now available in a desktop setting.

G. When cradled in the adapter is a video cell phone which includes a video screen to display an image of a party being spoken to and a video camera to pick up an image of the speakers the console configuration is such as to enhance these images.

H. An adapter in accordance with the invention for converting a cell phone into a desktop phone may be mass-produced at relatively low cost.

Briefly stated, these objects are attained in an adapter to convert a mobile cell phone having a battery-powered transceiver and a key pad into a desktop telephone, the adapter including a console that rests on a desk top and is provided with a cradle to nest tie cell phone. Next to the cradle is a socket to accommodate a hand set whose microphone and speaker are connected by a cord extending from the hand set to a plug inserted in a console jack.

The console jack is connected by an interface network to a plug mounted on the cradle. The cell phone is provided with a jack having contacts which are connectable to an external microphone and speaker to supplant these in the cell phone connected to its transceiver. Insertion of the cell phone in the cradle causes the cradle plug to engage the cell phone jack, thereby connecting the microphone and speaker of the hand set via the interface network to the transceiver of the cell phone whose key pad now functions as the dialing pad of the desktop phone.

The interface network is governed by a control switch which functions in two switching modes, the first of which takes effect when the hand set is in its socket, the second when it is lifted therefrom. In the first switching mode, the cell phone is rendered inactive except to receive a ring signal indicative of an incoming call. In the second switching mode, the cell phone is activated to convey the incoming call to the hand set.

### BRIEF DESCRIPTION OF THE DRAWINGS

For a better understanding of the invention as well as other objects and features thereof; reference is make to the annexed drawings wherein:

FIG. 1 is a perspective view of a preferred embodiment of an adapter in accordance with the invention to convert a cell phone into a desktop telephone provided with a hand set;

FIG. 2 is the same as FIG. 1 except that the hand set is shown removed from. its socket;

FIG. 3 is a separate view of the cradle in. the desktop telephone;

FIG. 4 shows a section of the socket which accommodates the hand set;

FIG. 5 is a block diagram of the desktop telephone;

FIG. 6 is a schematic circuit diagram of the desktop telephone;

FIG. 7 illustrates another embodiment of the adapter; and

FIG. 8 shows an adapter for converting a video cell phone into a video desktop telephone.

### DETAILED DESCRIPTION OF THE INVENTION

First Embodiment:

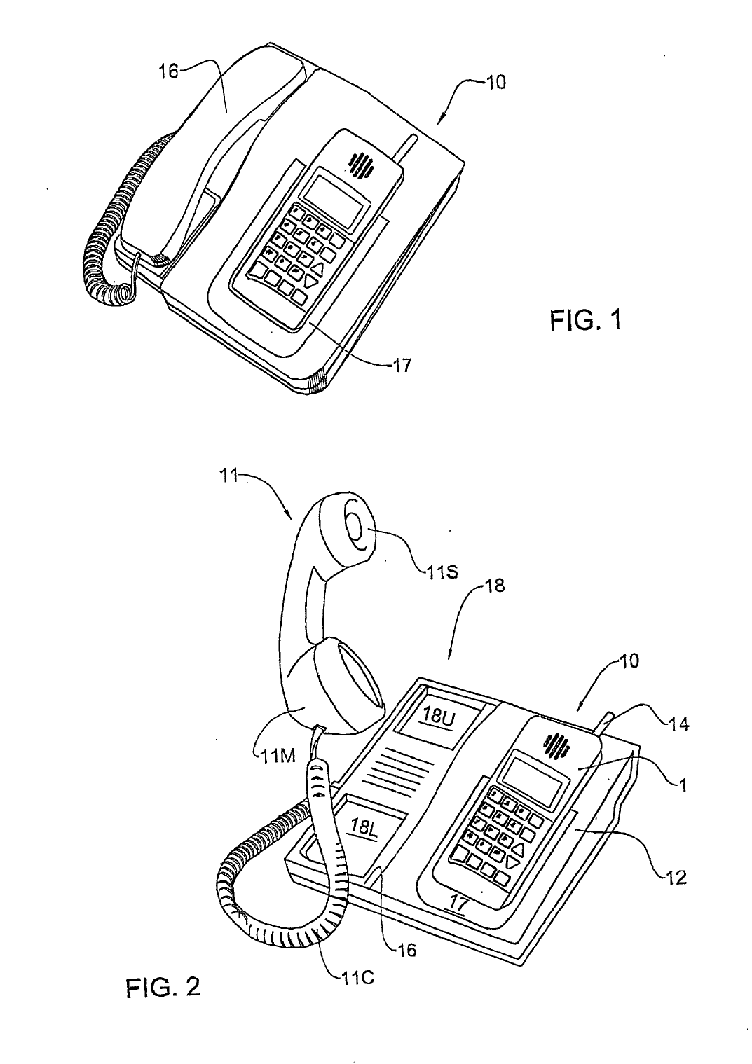

An adapter in accordance with, the invention acts to convert a mobile cell phone, such as cell phone 10 shown in FIGS. 1 and 2, into a desktop telephone provided with a standard hand set 11 having at its upper end a speaker section 11S and at its lower end a microphone section 11M, a cord 11C extending from the hand set.

The advantage of a hand set over a cell phone which also has a microphone and speaker, is that a hand set is anatomically contoured so that the earpiece of its speaker section 11S covers the ear of the user, whose bearing is then confined to the sounds coming out of the ear piece and excludes extraneous noise. And the mouthpiece of the microphone section 11M is then adjacent the mouth of the user and picks up mainly the voice of the user.

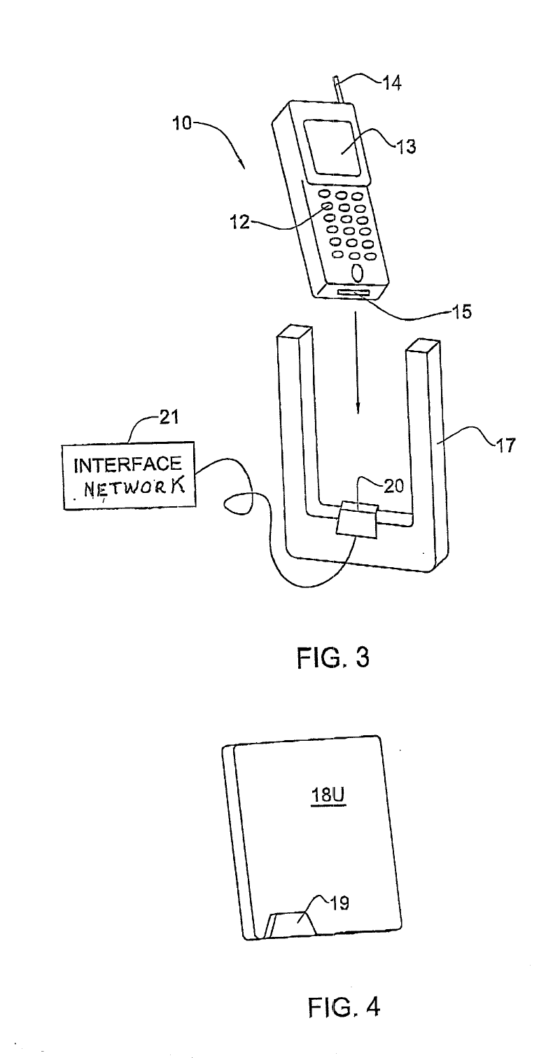

Cell phone 10, shown separately, in FIG. 3 includes a dialing keypad 12, an LCD display screen 13 and a short antenna 14. Antenna 14 emits microwave energy, but because it is situated in the adapter on a desk top, it is not close to the head of the user of the desk top telephone. Hence the user is not subjected to microwave radiation from the cell phone antenna. However, the cell phone is electrically coupled to the cord 11C of hand set 11 which then acts as an auxiliary antenna radiating microwave energy. To prevent microwave energy carried by the line connecting the cell phone to cord 11C, an R-F choke is interposed in this line, as will be later described.

Cell phone 10 includes a transceiver powered by a rechargeable battery. At the bottom end of cell phone 10 is a jack 15 having a set of contacts for connecting the rechargeable battery in the cell phone to an external charger. There are also contacts for connecting the transceiver of the cell phone to an external microphone and speaker. When. an external microphone and speaker are connected to the cell phone, they then supplant the internal microphone and speaker normally coupled to the transceiver.

The adapter includes a generally rectangular console 16 having a flat, cushioned base so that it can be rested on a desk or tabletop or on any other flat surface. A desktop telephone in accordance with the invention is wireless in the sense that it is not wired by a cable to a telephone line outlet or to a power line outlet, and the unit can therefore be carried about and placed wherever it suits the user's convenience.

Mounted on the face of console 16 is a U-shaped cradle 17 which is dimensioned to receive and nest cell phone 10, the arms of the cradle embracing the sides of the cell phone, and being joined together by a yoke.

In practice the arms may be provided with a retractable latching mechanism (not shown) to securely hold the cell phone in the cradle but which can easily be retracted to withdraw the cell phone from the cradle.

Next to cradle 17 nesting cell phone 10 is a socket 18 to accommodate hand set 11. Socket 18 has a lower section 18L to receive microphone section 11M of the hand set, and an upper section 18U to receive speaker section 11S.

Mounted within upper section 18U is a depressible control switch 19 which has two switching modes, the first being the mode resulting front depression of the the switch by the speaker section 11S, the second being the mode resulting from the return of the switch to its initial position when the hand set is lifted to take speaker section 11S out of upper socket section.

Control switch 19 acts to govern the operation of an interface network 21 to which cell phone 10 is connected by way of a plug 20 mounted in the yoke of cradle 17 to engage the jack 15 of the cell phone when it is inserted in its cradle. Interface network 21 couples cell phone 10 in the cradle via an JEFF choke 22 to a console jack 23 into which is plugged plug 24 of cord 11C extending from hand set 11.

R-F choke 22 acts to prevent cord 11C from behaving as an auxiliary microwave antenna radiating energy in the vicinity of the head of the user when holding the hand set against his ear. Choke 22 offers little resistance to the audio signal being fed on a line from the cell phone to the hand set but it presents a high impedance and load to microwave energy being carried by the line.

Control switch 19 governs the operation of interface network 21 in the following manner:

A. When hand set 11 is placed in socket 18, switch 19 is then depressed to function in a first mode which renders cell phone 10 inactive so that it is then in condition only to receive a ring signal indicative of an incoming call.

B. When the user hears the ring signal and lifts die hand set to tale the incoming call, switch 19 returns to its initial state to operate in a second mode activating the cell phone which now feeds the incoming audio signal via the interface network to hand set 11.

C. When the user wishes to make a call on the desktop telephone, he then lifts the hand set from its socket to switch from the first to the second switching mode which renders the cell phone active so that the user can now dial the number of the party to whom he wishes to speak.

The Circuits of the Desktop Telephone

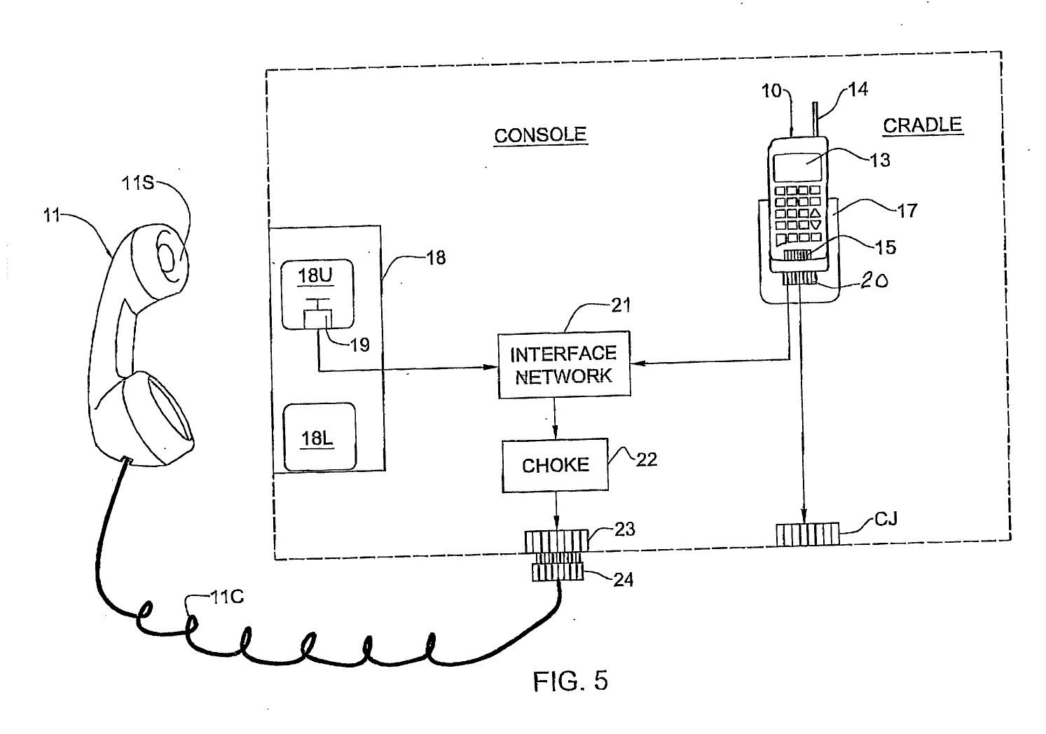

When the desktop telephone is in its operative state as shown in FIG. 5, cell phone 10 is then nested in cradle 17 and the cradle plug 20 is then inserted in cell phone jack 15, the cell phone now being connected to interface network 21 which is linked to hand set 11 via console jack 23 into which hand set cord 11C is plugged.

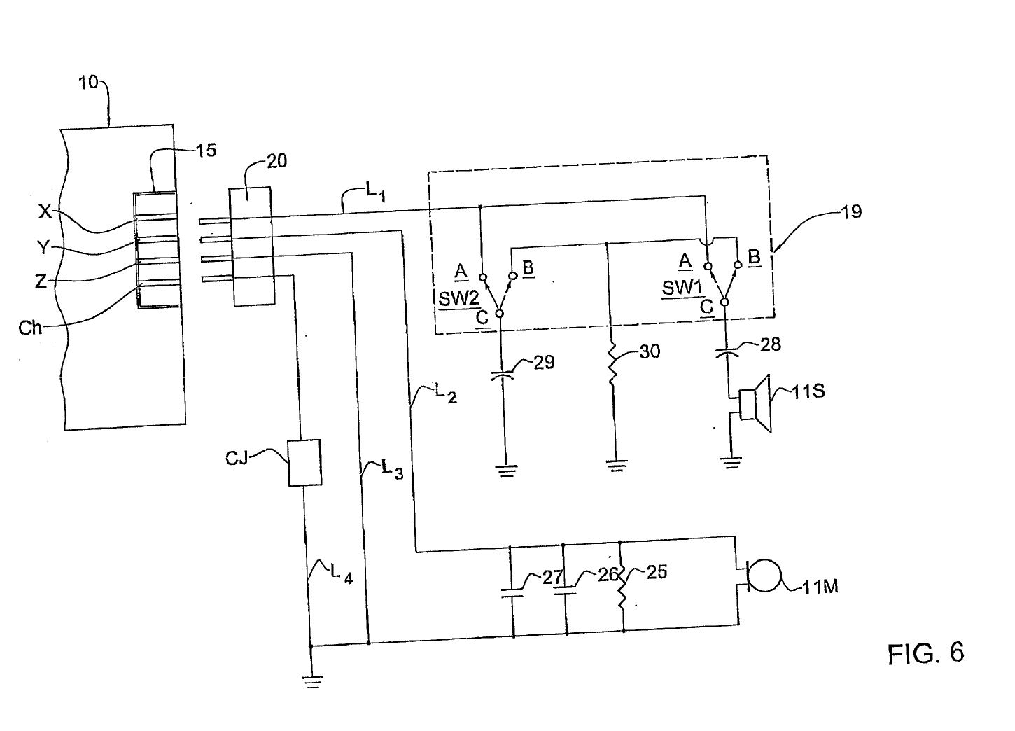

As shown in FIG. 6, control switch 19 which governs the operation of interface network 21 is composed of a pair of selector switch sections SW1 and SW2 each having fixed contacts A and B and a movable contact C adapted to engage either one of the fixed contacts. Movable contacts C of switch sections SW1 and SW2 are ganged together in opposition so that when movable contact C of switch section SW1 engages its fixed contact B, then movable contact C of switch section. SW2 engages its fixed contact A, and vice verse.

The fixed contacts A of switch sections SW1 and SW2 are both connected via a line L1 leading to cradle plug 20 which is plugged into cell phone jack 15 and engages the speaker X contact in the jack. Speaker contact X in cell jack 15 not only yields the audio signal from the cell phone transceiver but also its dc voltage (2.7 volts).

Contact Y in cell phone jack 15 is the microphone contact and therefore is connected by a line L2 to microphone section 11M in hand set 11 via a noise filter composed of a resister 25 in parallel with capacitors 26 and 27. This connection to line L2 is made by a prong in cradle plug 20 that engages the Y contact in cell jack 15. The noise filter acts to filter out the high-frequency noise components in the audio frequency spectrum of the signal picked up by the microphone. Hence what the user hears is substantially free of noise. The Z contact in cell jack 15 is connected by line L3 to ground, this being the common ground for the interface network and the noise filter. The CH contact in cell jack 15 is the battery charger contact which is connected by line L4 to a charger jack CJ mounted on the console. Hence to recharge the cell phone batter, it is not necessary to remove the cell phone from its cradle on the console, for all that need be done is to plug the charger into the charger jack CJ.

The connections between switch sections SW1 and SW2 of control switch 19 and the interface network composed of chargeable capacitors 28 and 29 and discharge resistor 30 and their functions will now be explained.

Movable contact C of SW1 is connected through capacitor 26 in series with speaker section 11S to ground. Movable contact C of SW2 is connected to ground through capacitor 29. Fixed contacts B of both SW1 and SW2 are connected to ground through resistor 30. Capacitors 28 and 29 and resistor 30 form the interface network 21 intercoupling the cell phone 11 with hand set 10 under the control of the hand set socket switch 19.

When haled set 11 is in place in the socket and control switch 19 is then depressed to assume its first operating mode, switch section SW2 then engages its contact A while switch section SW1 then engages its contact B as shown. in FIG. 6. Because contact A of SW2 is connected by line L1 to contact X of the cell jack 15, /capacitor 29 then connected to contact A of SW2 is charged by the dc voltage carried by line L1.

And since contact B of SW1 is now connected to capacitor 28, then capacitor which had previously been charged, now discharges in the first mode through speaker 11S, one end of which is grounded and through resistor 30, one end of which is grounded. In this first operating mode in which the hand set is placed in its socket, its speaker 11S is then disconnected from the cell phone which is inactive except to receive a ring signal indicative of an incoming call.

When in response to this ring signal the user lifts hand set 11 from its socket, switch 19 returns to its initial state (second mode of operation) in which SW1 engages its contact A and SW2 engages its contact B. When SW1 engages contact A it then connects capacitor 28 to line L1 to charge the capacitor with the dc voltage carried by this line. And at the same time it feeds the audio signal on line L1 to speaker 11S through contact B of SW1. But since capacitor 29 is now connected by contact B of SW1 to ground through resistor 30, the capacitor is then discharged.

When capacitor 28 is being charged, direct current is then sourced from cell phone 10, the resultant current surge being sensed to instruct the cell phone to connect the incoming call. When the call is completed and hand set 11 is returned to its socket to depress switch 19, switch sections SW1 and SW2 return to their initial state. As a consequence, the previously discharged capacitor 29 is again charged to produce a current surge that is sensed by tie cell phone to instruct it to disconnect the cell, while previously charged capacitor 28 is now discharged.

Thus interface network in conjunction with switching sections SW1 and SW2 which are first actuated by lifting the hand set from its socket and then by putting it back in place, create a monostable direct current one-shot device responsive to the handling of the hand set.

Desktop Telephone Geometry

A conventional desktop telephone requires a cable extending therefrom for connection to a telephone line wall outlet. This requirement, to some degree dictates the geometry of the phone, for in order to make the cable inconspicuous the console of the telephone is in a rectangular form with the cable extending from the rear end thereof so that it is not seen by those facing the telephone.

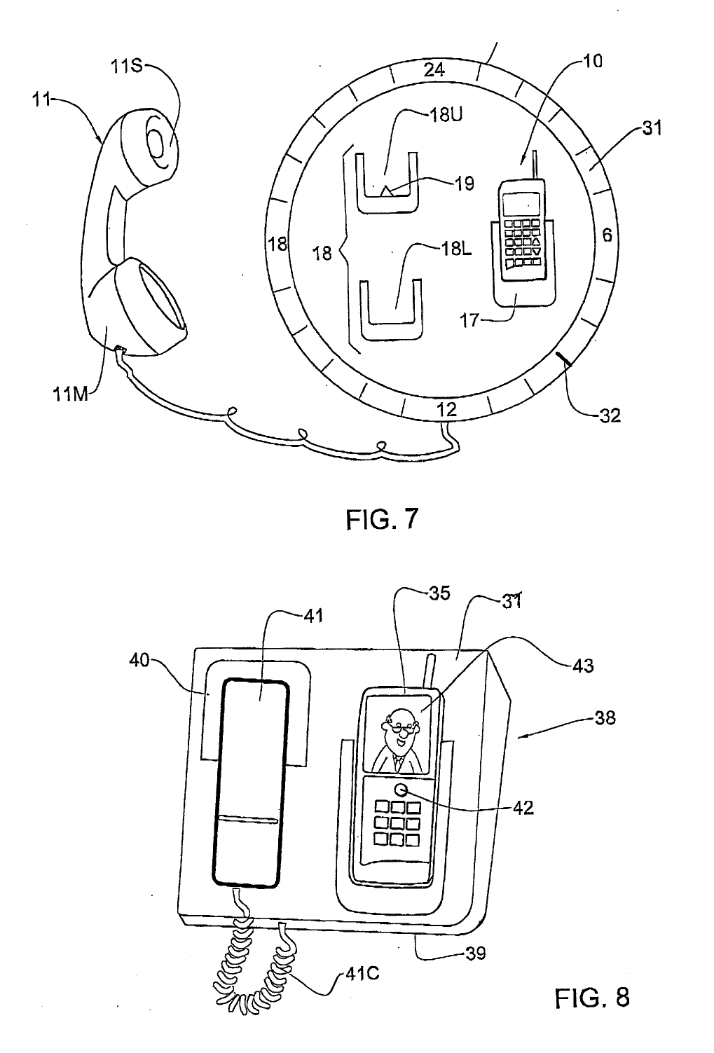

A desktop telephone in accordance with the invention is wireless and has no cable connections. This makes it feasible to provide console configurations having a geometry other than rectangular. Thus a prefered console configuration is one having a circular form as shown in FIG. 7. In this console, cradle 17 for cell phone 10 and the adjacent socket 18 for the hand set 11 are placed within a circular central. area defined by an annular scale 31 on the periphery of the console face. Scale 31 is a 24 hour timepiece scale created by an LCD screen display which is traversed by all electronic pointer 32 controlled by an electronic timepiece movement housed within the console.

By its very nature a circular console, when place on a desktop is more stable than a rectangular console. And since the desktop telephone is not tethered, the console may be provided will a retractable handle so that it can be hand carried to any desired site. It is then necessary to provide the socket sections 18U and 18L with a retractable latching mechanism to prevent the hand set from falling out of the socket when the telephone is being carried.

The hybrid clock-desktop telephone shown in FIG. 7 may be wall mounted simply by putting a keyhole slot in the back of the console to receive a screw anchored in the wall. The resultant wall telephone-clock then only tells the time but it also tells the user when a call is being made or received. Such information is important to those who need to keep track of incoming and outgoing calls.

Adapter for Video Cell Phone

A recent innovation in the technology of cell phones is the video cell phone. This phone is provided with a miniature video camera to obtain an image of the head of the user of the cell phone who is speaking into its microphone, a small scale video screen to display an image of the party to whom the user is speaking and a microwave television transceiver to transmit the voice and image of the speaker and to receive the voice and image of the party to whom the user is speaking.

One practical drawback of a video cell, phone which is band carried is that it is difficult when holding the cell phone to properly train the video camera onto the head of the holder while at the same time putting him in a position so as to clearly view the video screen.

But a more serious drawback of a video cell phone is that while it is a mobile instrument which can be used anywhere, one is ill advised to use it while walking or on a moving vehicle, for you cannot be looking at the video screen of a video cell phone while at the same the looking to see where you are going.

These drawbacks which impose restrictions on the use to which a video cell phone call be put are obviated in the adapter for a video cell phone illustrated in FIG. 8. This adapter is configured to convert a video cell phone into a video desktop telephone and to so orient the cell phone so that its video camera is properly trained on the head of the speaker, while he then sees a clear image on the screen of the video phone of the party to whom he is speaking.

As shown in FIG. 8, the video cell. phone 35 is nested in a cradle 36 mounted on the face panel 37 of a console 38 having a trapezoidal cross section. Face panel 37 is upwardly inclined with respect to the horizontal plane of the surface on which the base panel 39 of the console rests.

Adjacent cradle 36 on the console is the socket 40 for accommodating a hand set 41 whose cord is plugged into a console rack connected to an interface network, as in the other embodiment of adapters disclosed herein, the arrangement being generally similar to that shown in FIG. 1.

Video cell phone 35 is provided with a miniature video camera 42 and a small scale video screen 43 whose function is to display the head of the party to whom the user is speaking, this party having a similar video cell phone. It is to be noted that when it is difficult to understand what this party is saying because of noise and other interfering factors, that if one can at the same time read the moving lips of the speaker, this facilitates comprehension. It is therefore useful not only to be able to hear the speaker but also to see him clearly enough to observe his lips.

To this end it is important that the orientation of the video cell phone be such as to properly train the video camera in the cell phone toward the head of the user while bringing the video screen in line with the eyes of the user. To accomplish this result, the angle of inclination of face panel 38 lies in a 10 to 18 degree range so that a speaker seated before the desk on which the adapter is placed, can look down on the upwardly inclined video screen and clearly see the image being displayed thereon, the spealcer's face then being in alignment with the video camera 42 just below video screen 43.

Because desks come in different heights and some users are taller than others, there is no one optimal angle of inclination for the console of the adapter. Hence in practice, a manually-operated mechanism may be provided to adjust the angle of the face panel, or to adjust the angle of the cradle relative to the face panel so that it is appropriate to the user of the cell phone.

And instead of providing a band set, as shown, which plugs into the console to supplant the internal speaker and microphone of the cell phone, one may plug into the console a head set which sits on the head of the user and is provided with ear phones and a microphone.

Also one can plug into the console jack a self-sufficient speaker phone unit that includes a microphone, a loud speaker and a battery-powered amplifier. This makes possible hands-free operation of the cell phone.

When the cell phone is of the type that includes an internal electronic switching circuit adapted to activate and deactivate the transceiver in response to an external switching action, jack 20 of the cell phone then has a contact therein connected to this internal switching circuit. The interface between hand set socket switch 19 and the switching contact of jack 20 can simply be a wire extending from the socket switch to a plug that plugs into tie jack to engage the switching contact. As a consequence, the adapter causes this cell phone to behave like a regular desktop telephone, for when the hand set is lifted from its sockets this action activates the transceiver so that the user can now on the keypad dial a number. And when the user returns the hand set to its socket, this action deactivates the transceiver.

In practice, an LED pilot light can be included in the interface network to be switched on when the hand set is lifted from of the socket to indicate that the phone is now active, and is switched off when the phone is returned to its socket. Should the LED not turn on when the band set is lifted, this indicates that the battery is dead and requires recharging.

While there have been shown preferred embodiments of the invention, it is to be understood that many changes may be made therein without departing from the spirit of the invention. Thus the interface network may include a tone generator for producing a dial tone, the generator being activated for a brief period when the user lifts the hand set from its socket to made a call. And the hand set instead of having a cord which must be plugged into the console may be of the wireless type Also to improve transmission and reception by the cell phone transceiver, the adapter may be provided with a high-efficiency antenna that connects to the transceiver when the cell phone is inserted in its cradle.

1. An adapter for converting into a desktop telephone a cell phone provided with a keypad, a rechargeable battery and an internal microphone and speaker coupled to a microwave transceiver, said adapter comprising:
A. A console having a cradle thereon in which to nest die cell phone so that its keypad is exposed;
B. A socket on the console adjacent the cradle to accommodate a hand set provided with a microphone arid a speaker, and a cord connected to the microphone and speaker extending from the hand set;
C. An interface network coupling the cell phone in the cradle to the cord of the hand set whereby the microphone and the speaker in. the hand set supplant those in the cell phone; and
D. Switching means governing the operation of te network and responsive to the placement of te hand set by a user whereby when the hand set is placed in the socket, the transceiver is then rendered inactive except to receive a signal indicative of an incoming call, and when the hand set is lifted from the socket to take the call, this action activates the transceiver.

2. An adapter as set forth in claim 1, in which the cord terminates in a plug that is insertable in a jack mounted on the console which is connected to said network to couple the hand set thereto.

3. An adapter as set forth in claim 1, in which the switching means includes a depressible switch located in said socket which is depressed when the hand set is placed therein.

4. An adapter as set forth in claim 1, in which said hand set includes a microphone section and a speaker section, and said socket is formed by corresponding lower and upper sections.

5. An adapter as set forth in claim 4, in which the switch is mounted in the upper section of the socket.

6. An adapter as in claim 1, in which the cradle is U-shaped to define a pair of arms which embrace the cell phone inserted therein and are jointed by a yoke.

7. An adapter as set forth in claim 6, further including a plug mounted in said yoke and connected to the interface network, the plug being inserted into a jack at one end of the cradle when the cell phone is inserted into the cradle whereby the cell phone is then connected to the network.

8. An adapter as set forth in claim 1, in which there is interposed in a line extending from the microphone in the hand set to the transceiver in the cell phone a noise filter that filters out noise components in the sounds being sensed by the microphone.

9. An adapter as set forth in claim 1, further including a retractable latch in said socket adapted to retain the hand set placed in the socket when the desktop telephone is being carried.

10. An adapter as set forth in claim 1, wherein said interface circuit includes means responsive to the placement of the hand set by the user to produce in the transceiver when the hand set is placed in the socket a current surge which acts to render the transceiver inactive, and when the hand set is lifted from the socket, a current surge which reactivates the transceiver.

11. An adapter as set forth in claim 10, in which the circuit means includes a first capacitor connected by the switching means to said transceiver to be charged by a voltage derived from the battery when the hand set is placed in the socket to produce a current surge which renders the transceiver inactive.

12. An adapter as set forth in claim 11, in which the circuit means includes a second capacitor connected by the switching means to said transceiver to be charged by a voltage derived from the battery when the hand set is lifted from the socket to produce a current surge which reactivates the transceiver.

13. An adapter as set forth in claim 12, in which the interface circuit includes a resistor which acts when the first capacitor is being charged to then discharge the second capacitor, and when the second capacitor is being charged to then discharge the first capacitor.

14. An adapter as set forth in claim 1, in which the console has a rectangular form and said cradle is mounted adjacent one side thereof and the socket is formed adjacent the opposite side.

15. An adapter as set forth in claim 1, in which the console has a circular form and said cradle and said socket are mounted within a circular area concentric with the periphery of tie console.

16. An adapter as set forth in claim 15, in which surrounding the circular area is an annular LCD time scale associated with an electronic timepiece disposed within, the console to produce a pointer which traverses the scale.

17. An adapter as set forth in claim 1, in which the cell phone cradled therein is a video cell phone provided with a microphone to pick up the voice of a speaker, a video camera to pick up an image of tde speaker, a video screen to display an image of tic party being spoken to, and a television transceiver to transmit the voice and image of the speaker and to receive the image and the voice of die party.

18. An adapter as set forth hi claim 17, having an upwardly inclined face on which the cradle is mounted, the face having an angle of inclination at which the video camera is properly trained off the head of the speaker to obtain a clear image thereof.
